(19) United States
(12) Patent Application Publication
(10) Pub. No.: US 2005/0160908 A1
(43) Pub. Date: Jul. 28, 2005

(54) Electrode mounting

(76) Inventor: Peter Kukla, Manchester (GB)

Correspondence Address: MICHAEL BEST & FRIEDRICH, LLP, 100 E WISCONSIN AVENUE, MILWAUKEE, WI, 53202, US

(21) Appl. No.: 10/506,450

(22) PCT Filed: Mar. 3, 2003
(86) PCT No.: PCT/GB03/00873

(30) Foreign Application Priority Data
Mar. 1, 2002 (GB) 0204927.8
Jul. 13, 2002 (GB) 0216301.2

(51) Int. Cl. B03C 3/40

(52) U.S. Cl. 96/83

(57) ABSTRACT

There is disclosed a mounting apparatus for an electrode, the mounting apparatus comprising a body (2) with means (4) for mounting an electrode (6), whereby in use the body (2) is partly about the electrode (6) and the electrode (6) projects from the body (2), the apparatus further comprising at least one external protrusion (12) on the body (2).

### FIELD OF THE INVENTION

The present invention relates to mounting apparatus for electrodes and to pollutant removal systems incorporating the same. In particular, but without limitation, the present invention relates to mounting apparatus for electrodes used in the separation of pollutants, especially particulates from gas streams.

### BACKGROUND TO THE INVENTION

It is known to attempt to separate particulate pollutants from a gas stream by charging the particulates, typically by corona discharge from an electrode and using the electrostatic properties of the charged particulates to separate them from the gas flow stream. This is referred to as electrostatic precipitation.

The present inventor has found that while it is possible to operate such a system on a small scale for a short period of time, the performance of any such equipment degrades over time. It is believed that one reason for such degradation is the tendency of current to flow from the electrode to earth. Typically the nearest earth is the mounting bracket for the electrode support.

Preferred embodiments of the present invention aim to obviate or overcome disadvantages of the prior art, whether referred to herein or otherwise.

### SUMMARY OF THE INVENTION

According to the present invention in a first aspect, there is provided a mounting apparatus for an electrode, the mounting apparatus comprising a body with means for mounting an electrode, whereby in use the body is partly about the electrode and the electrode projects from the body, the apparatus further comprising at least one external protrusion on the body.

Such an apparatus provides a tortuous route for current from the electrode along the body thus reducing current leakage.

Suitably, the body is generally cylindrical and the projection is generally radial relative thereto. Suitably, the body has a relatively thinner cylindrical elongate section. Suitably, the relatively thinner cylindrical elongate section is towards the distal end of the body. A less thick ceramic over an electrode is believed to encourage burn off of deposited carbon-based pollutants.

Suitably, the at least one protrusion is annular (ie 360°) about the body.

Suitably, the body and the at least one protrusion are a one piece structure.

Suitably, the body at least partly comprises a high electrical resistance material. Suitably, that part of the body to be in contact with the electrode comprises a high electrical resistance material. A suitable high electrical resistance material is ceramic material.

Suitably, the electrode mounting apparatus is suitable for a pollutant removal system.

Suitably, the apparatus comprises a section of or attached to the body which section comprises means for permitting the body to be mounted.

Suitably, the body is substantially circular cylindrical.

Suitably, the non-protruding regions substantially cylindrical.

Suitably, the at least one protrusion is generally conical externally. Suitably, the at least one protrusion is at least partly hollow. Suitably, the at least one protrusion is rebated. Suitably, the protrusions are tapered.

Suitably, all of the body comprises substantially the same material. This reduces manufacturing costs and helps minimise problems caused by differing thermal expansion coefficients for other materials.

Suitably, there are a plurality of protrusions spaced along the body. Suitably, the protrusions are substantially similar. Suitably, the protrusions are equally spaced along the body.

Suitably, the body is generally cylindrical.

Suitably, the body includes a hole therethrough for mounting an electrode therein. Suitably, the hole is longitudinal.

According to the present invention in a second aspect there is provided an electrode mounting apparatus comprising a mounting apparatus according to the first aspect of the invention, the apparatus further comprising an electrode about which the body is located.

Suitably, the electrode is mounted from one end only. Suitably, the electrode projects from an end of the body for forming a corona discharge.

According to the present invention in a third aspect, there is provided a pollutant removal system for at least partly removing at least one pollutant from a gas flow stream, the system comprising an electrode mounting apparatus according to any preceding aspect of the invention.

Suitably, the system comprises means for diverting pollutants to a pollutant remover. In the case of particulate pollutants the remover may be a filter.

Suitably, the system comprising means for charging particulates in the gas stream and a tube through which the gas stream at least partly flows, whereby the tube is at least partly porous to the gas stream and the apparatus additionally comprises means for collecting at least one pollutant.

Suitably, the tube is at least partly about the charging means. Suitably, the charging means comprises an electrode.

Suitably, the tube is perforated. Suitably, the tube comprises a plurality of holes therethrough. Suitably, the holes are evenly spaced. Suitably, the holes are evenly sized. Suitably, the perforated region of the tube is substantially annular. Suitably, the perforated region of the tube extends for a substantial length thereof.

Suitably, the tube comprises at least one slot therethrough. Suitably, a plurality of slots is provided. Suitably, the slots are substantially evenly distributed about the tube. Suitably, the at least one slot runs longitudinally along the tube.

Suitably, a major portion of the tube is porous. Alternatively a minor portion of the tube is porous.

Suitably, the tube is circular in cross-section. Suitably, the tube comprises an inlet and an outlet.

Suitably, the cross-sectional area of the tube decreases along its length from the input to the output thereof.

Suitably, the electrode is mounted at one end thereof only.

Suitably, there is a first gas flow path from an apparatus gas inlet to an apparatus gas outlet and a second gas flow path from the apparatus gas inlet to the apparatus gas outlet. The first and second gas flow paths may be in common for a part thereof. Suitably, a filter is located in the second gas flow path. Suitably, the tube is located in the first and second gas flow paths. The tube acts to split the gas flows and concentrate at least one pollutant in one flow path for subsequent removal.

Suitably, the arrangement comprises a gas flow tube for the second flow path, which gas flow tube comprises a slot for the first gas flow path to join the second gas flow path.

Suitably, the first gas flow path splits from the second gas flow path at a separator for diverting pollutant to the pollutant removing means. Suitably, the separator is generally conically shaped with an opening for one of the gas flow paths therethrough.

Suitably, the system comprises a first expansion tube in fluid communication with an apparatus gas inlet. Suitably, the diverting tube extends from the first expansion tube to a second expansion tube defined by the tube. Suitably, there is a third expansion tube about the diverting tube into which gas can flow through the diverting tube. Suitably, a filter is located between (in respect of gas flow) the second and third expansion tubes.

Suitably, the filter comprises an electrically regenerative filter.

Suitably, the system is for removing pollutants from an exhaust gas stream, preferably a vehicle exhaust gas stream.

Suitably, the system is for use in an exhaust gas flow stream. Suitably, the system is for use in a vehicle exhaust gas flow stream, preferably a diesel exhaust.

Suitably, the electrode is for corona discharge ionisation of a gas flow stream.

Suitably, the tube is at least partly coated with a resistive coating.

### BRIEF DESCRIPTION OF THE DRAWINGS

The present invention will now be described, by way of example only, with reference to the drawings that follow; in which:

FIG. 1 is a plan view of a first mounting body for mounting an electrode according to a first embodiment of the present invention.

FIG. 2 is a plan view of a second mounting body for mounting an electrode according to a second embodiment of the present invention.

FIG. 3 is an enlarged sectional view of FIG. 1, the section being taken along a plane of the axis of the body of FIG. 1.

FIG. 4 is a cross-sectional view of a mounting body for mounting an electrode according to a third embodiment of the present invention.

FIG. 5 is a cross-sectional schematic view of a particulate diversion apparatus according to an embodiment of the present invention.

FIG. 6 is a schematic, perspective, partly cut-away view of the apparatus of FIG. 5.

FIGS. 7-10 are cross-sectional schematic views similar to FIG. 5 of second to fifth embodiments of the present invention.

FIG. 11 is a perspective illustration of elements of the FIG. 10 embodiments.

FIG. 12 is a cross-sectional view of a mounting body as shown in FIG. 10.

FIG. 13 is a plan elevation (external walls cut away) of an apparatus according to a further embodiment of the present invention.

FIG. 14 is a side elevation of FIG. 13.

FIG. 15 is a perspective illustration of FIGS. 13 and 14.

FIG. 16 is a plan elevation (external walls cut away) of an apparatus according to a yet further embodiment of the present invention.

FIG. 17 is a perspective illustration of FIG. 16.

FIG. 18 is a plan view of a yet further embodiment of the present invention.

FIG. 19 is a side elevation of FIG. 18.

FIG. 20 is a sectional, inverted plan view corresponding to FIG. 18.

### DESCRIPTION OF THE PREFERRED EMBODIMENTS

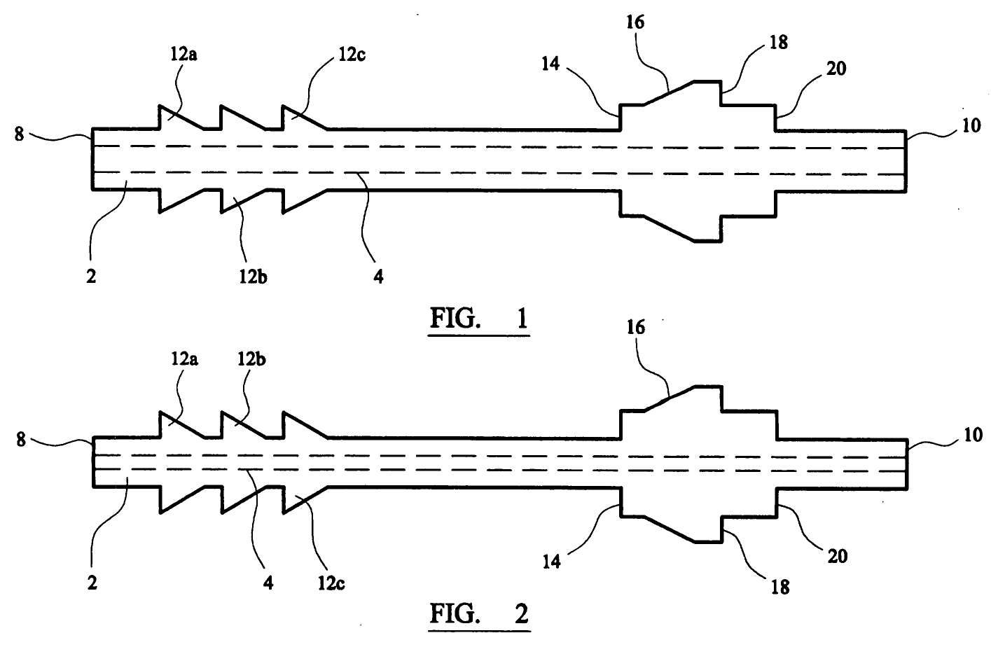

Referring to FIG. 1 of the drawings that follow, there is shown a plan view of an electrode mounting body 2, made from a ceramic, electrically substantially non-conducting material, here alumina or SINTOX FF (trade mark). Typically, the non-conducting material will contain at least 80% and normally at least 90% alumina. Preferred embodiments contain more than 95%, or more than 97%, and most preferably more than 99% alumina.

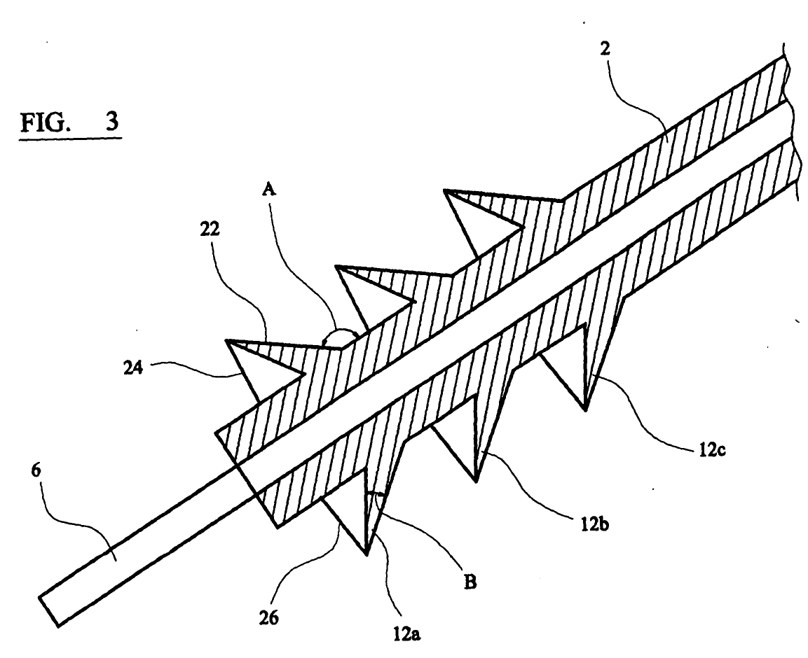

The body 2 is substantially circular cylindrical and includes a cylindrical hole 4 (dashed lines) along the axis thereof through which an electrode 6 is to be mounted. The hole 4 acts as means for mounting an electrode The electrode 6 projects from a first end 8 of the body 2, which projecting portion of electrode 6 (see FIG. 3) forms a corona discharge electrode in use. A second end 10 (opposite first end 8) of body 2 allows the electrode to be connected to a power source (not shown). It is noted that the electrode 6 is mounted from one end only. Thus the electrode 6 has a mounting end (second end 16) and an electrode projecting end (first end 8).

From the first end 8, the body 2 is initially generally circular cylindrical. The body 2 is then interrupted by three substantially similar protrusions 12a, 12b and 12c. The protrusions 12a, 12b and 12c are described in more detail in relation to FIG. 3 below. The protrusions 12a, 12b and 12c are separated from one another and from the first end 8 of body 2.

After the protrusions 12a, 12b and 12c, the body 2 is again circular cylindrical until it reaches a shoulder 14 leading to an outwardly flared section 16 from which there is a first step 18 and a second step 20. The section of body 2 from shoulder 14 to second end 10 provides a structure for the body 2 to be held in a mounting bracket (not shown) or the like. Typically, the mounting bracket will be of a hard anodised metallic material, typically aluminium. It is to the mounting bracket that the protrusions 12a, 12b and 12c discourage current flow.

The protrusions 12a, 12b and 12c are separated from the bracket mounting structure by a distance substantially greater than the distance from the protrusions to the first end 8. In this case the distance measured in each case to the most distant protrusion.

FIG. 2 of the drawings that follow is an electrode mounting body substantially similar to that of FIG. 1 except that it varies in the dimensions used.

Referring now to FIG. 3 of the drawings that follow, there is shown an enlarged view of the section of electrode 2 incorporating the protrusions 12a, 12b, 12c.

Only the protrusion 12a will be described in detail as the other protrusions 12b and 12c are substantially similar.

Considered from first end 8, protrusion 12a comprises an inverted cone 22 that tapers towards the first end 8 with an internally truncated hollow volume 24 whereby the path from the projecting portion of electrode 6 to earth is substantially increased and made significantly more tortuous.

The cones 22 form flared flanges, extending outwardly towards the electrode projecting first end 8 of the body 2.

The cone 22 forms a protrusion shoulder 26.

In this example the diameter of the hole 4 for the electrode 6 is about one-third of the diameter of body 2 (measured at a region and which the body 2 constantly is cylindrical). In this example the protrusion shoulders 26 protrude for about half of the diameter of the body 2 (measured at a region at which the body 2 is constantly cylindrical).

The external angle A of the cone 22 to the body 2 (where it is of constant diameter for a region) is 130°. The internal angle of the cone (between faces) is 16°.

The protrusions provide a tortuous conductivity pathway from the electrode reducing current loss.

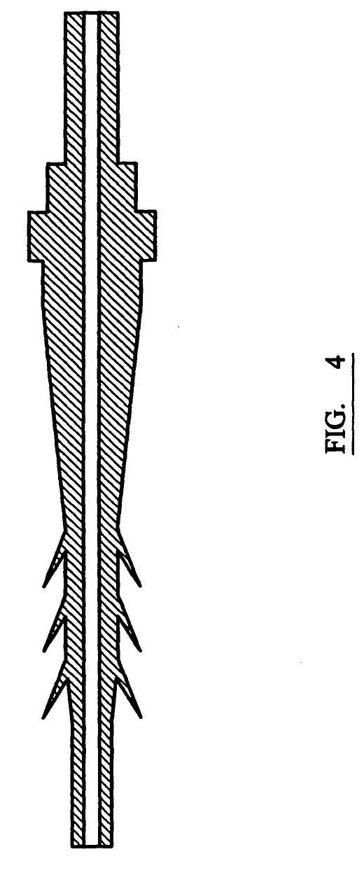

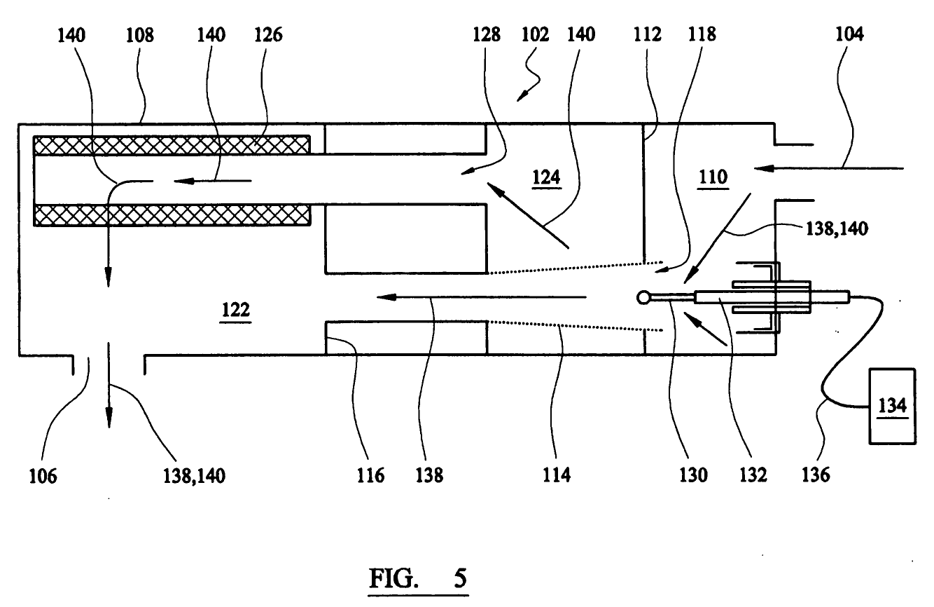

The mounting arrangement described herein is preferably for a pollutant, preferably a particulate removal system in which a gas stream passes the charged electrode, which charges particulates in the gas stream which can then be separated from the gas stream by electrostatic separation. Such a system incorporating the mounting arrangement described above is described briefly with reference to FIG. 4 of the drawings that follow.

FIG. 4 show an alternative mounting arrangement embodiment in which similar reference numerals are used for like parts. The annular cones 22 are move inclined and further tapered than the embodiments of FIGS. 1-3. The diameters of the cones 22 may vary. Where the diameters vary, there will be an increase in diameter from the first end to the second end.

It will be appreciated that the number, spacing and shape of the protrusions may vary.

Referring to FIG. 5 of the drawings that follow, there is shown an apparatus 102 for diverting pollutants, especially particulates from gas streams. The apparatus 102 is mounted in a vehicle exhaust (not shown), typically in a silencer thereof, through which inflowing exhaust gas enters at 104 and exits at 106.

The apparatus 102 comprises an outer body 108, typically of sheet steel. Within body 108 there is defined a first expansion chamber 110 defined by internal wall 112 leading to a perforated elongate tubular field tube 114 defining a chamber mounted to outer body 108 by internal walls 112 and 116.

The tube 114 comprises a tube inlet 118 in first expansion chamber 110 and a tube outlet 120 in a second expansion chamber 122 defined in part by internal wall 116. The tube 114 is circular cylindrical and its cross-sectional diameter decreases at a constant rate from the tube inlet 118 to the tube outlet 120. The tube 114 is perforated by a multiplicity of evenly sized and spaced circular holes from the tube inlet 118 to the intersection of tube 114 with internal wall 116. From internal wall 116 to tube outlet 120 the tube 114 is solid. A major proportion, around 80% of the tube 114 is holes in the perforated region thereof. The tube 114 is substantially porous to gas flow.

A third expansion chamber 124 is located about the perforated tube 114. Third expansion chamber 124 is defined by internal walls 112 and 116. A further gas flow path is provided from third expansion chamber 124 to second expansion chamber 122 via filter 126 fitted to an outlet 128 in internal wall 116 of third expansion chamber 124. The filter 126 is an electrically regenerative filter such as that available from 3M under part number SK-1739. The filter 126 is wired for electrical regeneration though, for simplicity, this is not shown. The exhaust gas can pass to second expansion chamber 122 to apparatus outlet 106.

The electrode 6 is shown in the ceramic electrode holder body 2 and projects into tube 114 along the axis thereof for part of the length of the perforated section thereof. Electrode 6 projects into the part of tube 114 in third expansion chamber 124. Electrode 6 is connected to a high voltage power supply 134 by connection means 136.

It is noted that two gas flow paths are provided between gas inlet 106 and gas outlet 108. First 138 and second 140 gas flow paths 138 and 140 respectively are indicated by respective lines and arrow heads. First flow path 138 follows the following route: inlet 104, first expansion chamber 110, tube 114, second expansion chamber 122 to outlet 106. Second flow path 140 follows the following route: inlet 104, first expansion chamber 110, tube 114, third expansion chamber 124, filter 126, second expansion chamber 122 to outlet 106.

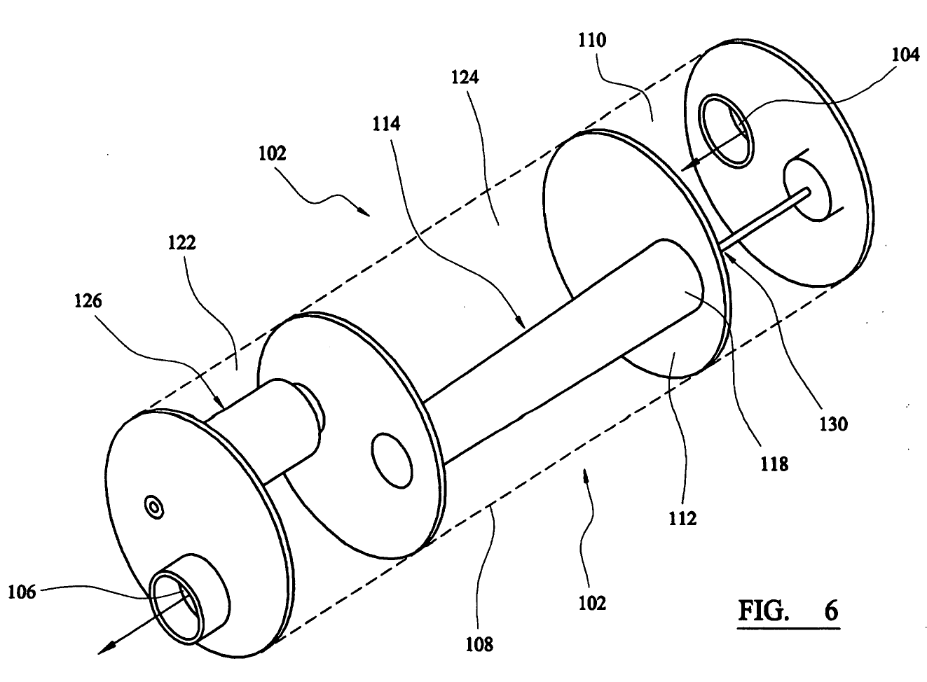

FIG. 6 shows the apparatus 108 with the outer body 8 cut-away for clarity.

In use, the electrode 2 is charged to 18-40 kV negative dc polarity. When vehicle exhaust gas enters the tube 114, a substantial proportion of particulates are ionised as they pass the electrode 2. Charged particulates are attracted to the floating earth perforated chamber wall 114. The momentum of the particulates and the acceleration acquired from their attraction to tube 114 generally causes them to pass through the perforated wall of tube 114. It can be said that the particulates are diverted into a second gas flow stream separate from the first gas flow stream. The filter 126 is in one of the gas flow streams only, here the second gas flow stream. Some of the exhaust gas exits tube outlet 120 following first flow path 138. However, a proportion of the exhaust gas follows second flow path 140 and helps convey the diverted particulates to filter 126. The exhaust gas then passes through filter 126 which collects particulates being conveyed to it by the exhaust gas.

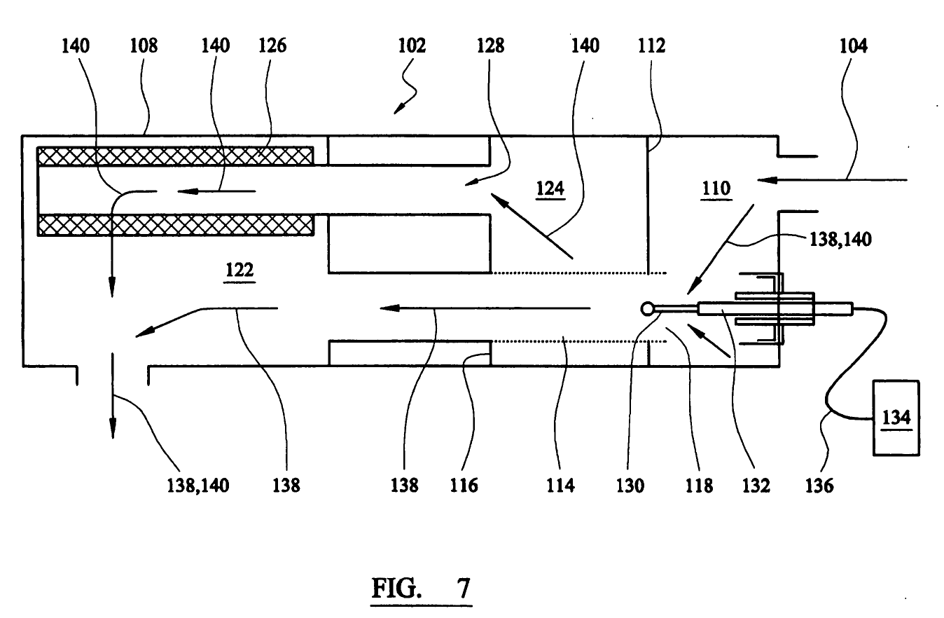

Referring to FIGS. 7-9 of the drawings that follow, three further embodiments of the present invention are shown, similar to the FIGS. 5 & 6 embodiment except as set out below. In FIGS. 7-9 like reference numerals are used for parts similar to the FIGS. 5 & 6 embodiment.

In the FIG. 7 embodiment the tube 114 is of substantially constant diameter instead of tapering downstream. The FIG. 7 embodiment may not perform as well as the FIGS. 5 & 6 embodiment, though it is still believed to be an improvement out known proposals and may be easier to manufacture.

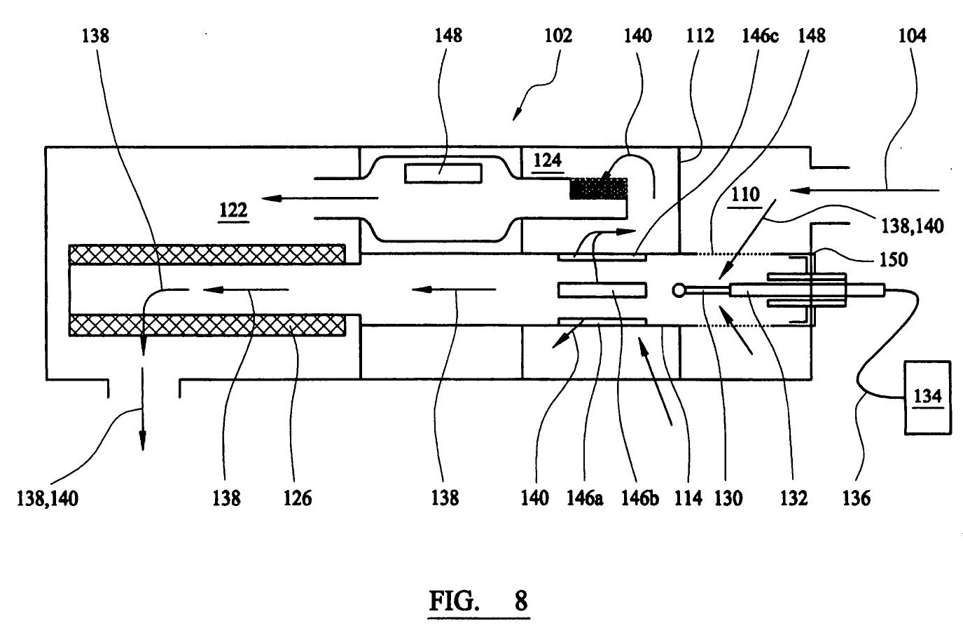

In the FIG. 8 embodiment the perforations in tube 114 are replaced by four equally spaced longitudinal slots, of which three are visible (at least in part) 146a, 146b and 146c. The slots 146 are porous to gas flow, but only provide gaps through tube 114 for a minor proportion thereof. Thus, particulates diverted towards tube 114 are far less likely to pass therethrough. As a result the more pollutant concentrated gas flow tends to be along first flow path 138 in which, in this embodiment, filter 126 is located.

Additionally in FIG. 8, a catalytic converter 148 is located in the second flow path 140, though it is noted that the apparatus 102 can function upstream and/or downstream of a catalytic converter.

FIG. 8 also shows a further modification in which a perforated section of tube 114 extends to the mounting arrangement 150 of electrode 130.

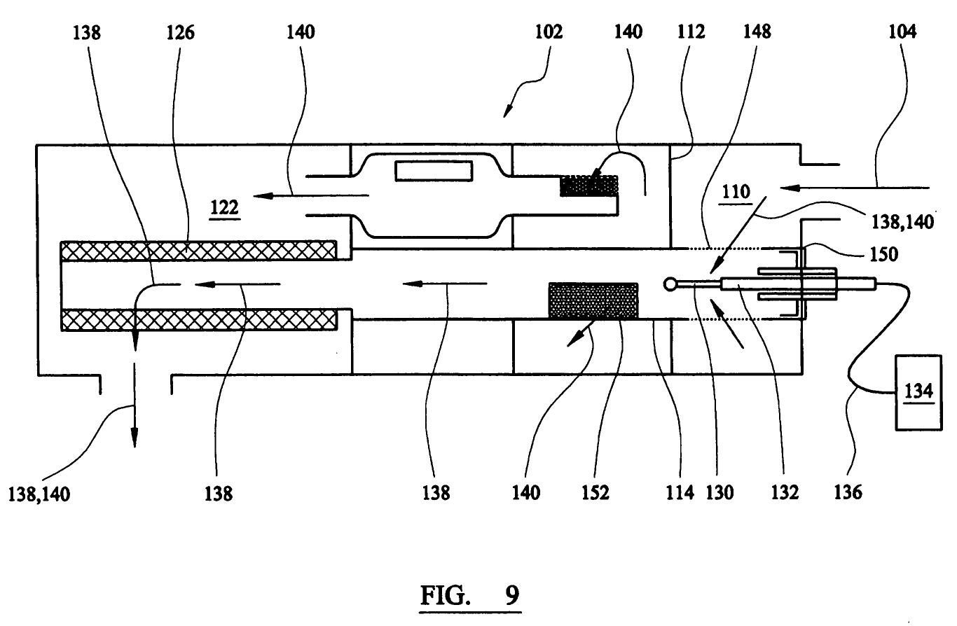

The embodiment of FIG. 9 operates in a manner substantially similar to that of the FIG. 8 embodiment, except that a perforated section 152 of tube 114 is provided for a minor proportion thereof.

Thus both the FIG. 8 and 9 embodiments provide gas porous regions only for a minor portion of tube 114.

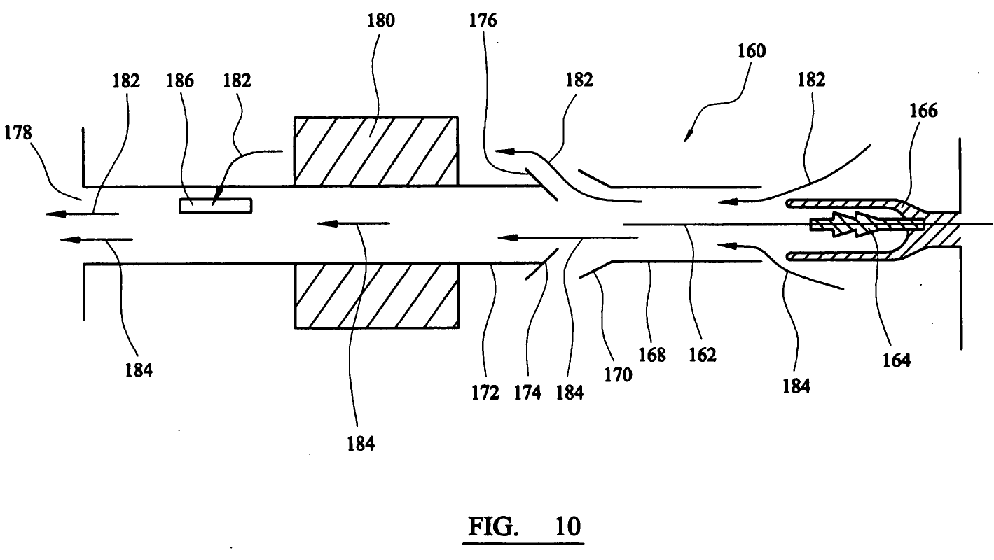

Referring to FIGS. 10 and 11 of the drawings that follow, there is shown a gas flow arrangement apparatus 160 for use in a pollutant removal device in which outer walls are not shown for clarity. The apparatus 160 comprises an ionising electrode 162 in an electrode mount 164, partly surrounded by an electrode hood 166. Electrode 162 extends into an electrode tube 168 which terminates in an outwardly diverging end 170. Spaced from electrode tube 168 is a second gas flow path tube 172 having a generally conically shaped entrance 174 with a central opening 176. The opening 176 is substantially inside the diameter of the walls of electrode tube 168. Tube 172 terminates in an exit 178. About tube 172 is a catalytic filter 180 for at least partly removing pollutants from a gas stream passing therethrough.

Operation of the embodiment of FIGS. 10 and 11 is similar to that of the embodiment described above. Exhaust gases, carrying pollutants, enter the apparatus 160 upstream of electrode 162, and pass over hood 166 which serves to help prevent pollutant build up on electrode 162. The electrode 162 is charged to ionise pollutants in the gas flow, which pollutants are therefore attracted to the walls of electrode tube 168 as they flow downstream, leaving relatively cleaner gas towards the centre of the flowstream. The conical opening of second gas flow path tube 172 serves to help deflect pollutant into a first gas flow path (indicated schematically by arrows labelled 182, while the second gas flow path is indicated by arrows labelled 184). The first gas flow path 182 passes through filter 180, which removes some pollutants, and rejoins second gas flow path 184 through a slot 186 in tube 172 downstream to the filter 100. The slot 186 is relatively small compared to the surface area of tube 172. The pressure difference either side of slot 186 is believed to encourage now relatively cleaner gas from the first gas flow path downstream of filter 180 to rejoin the second gas flow path. Second gas flow path 104 passes through second gas flow path tube 172 carrying relatively cleaner gas. The rejoined gas streams, pass out of the apparatus at exit 178.

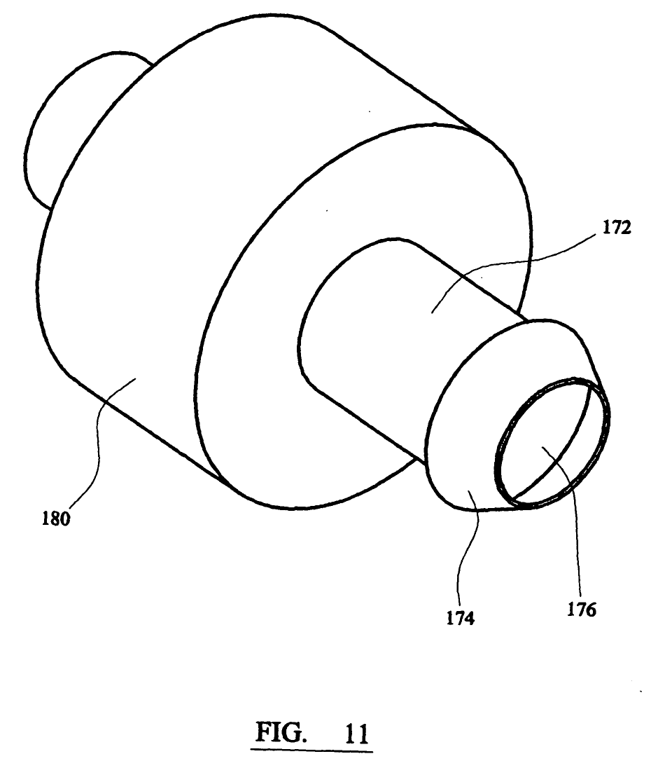

Referring to FIG. 12 of the drawings that follow, an alternative electrode mounting arrangement is shown. Both the electrode mount 164 and electrode hood 166 are formed from a ceramic material.

The electrode mount 164 includes a first portion 165 and a second portion 167 extending therefrom includes annular protrusions 188 of decreasing diameter towards the distal end 190 thereof. A relatively thinner elongate cylindrical section 192 is provided at the distal end of the mount 164, which increases the electric field in that region externally of the mount 164 when an electrode is active, encouraging burn-back of carbon based deposits. This is believed to result from sparking.

Hood 166 substantially surrounds (except for one end 194) electrode mount 164 and helps reduce deposits on the mount 164. The hood 166 is generally cylindrical, open at one end 194, with the other end having a complementary seating 196 for the electrode mount 164. In use second portion 167 projects from the open end 194 of hood 166 and an electrode project from the end of second portion 167.

The second ceramic mounting portion 167 is of a reduced external diameter compared with the first ceramic mounting portion 165. The electrode mount 164 can be formed from a single ceramic. Thus the electrode mount 164 has a portion of a first diameter and a portion of a lesser diameter towards the distal end (from which the electrode projects) thereof. The second portion 167 of second diameter extends a substantial distance beyond hood 84 typically at least 30 mm.

It is noted that although the maximum exterior diameter of each generally conically shaped protrusion 83 decreases in a downstream direction, the minimum internal diameters are substantially the same +10% between protrusions. This is believed to provide additional burn-off points if required.

The hood 166 protects a substantial part of the electrode mount 164 from the inflow of pollutant containing gas thus minimising the risk of shorting. However, it is believed that at least a 30 mm length of the electrode mount 164 needs to project beyond the hood. It is noted that the gas inlet is not around the electrode but rather alongside it and can be protected from it by the hood 84.

The electrode mount and hood can be glazed to reduce pitting of the surface and hence the build up of particulars thereon. The glaze acts as a means for smoothing the surface of the electrode mount.

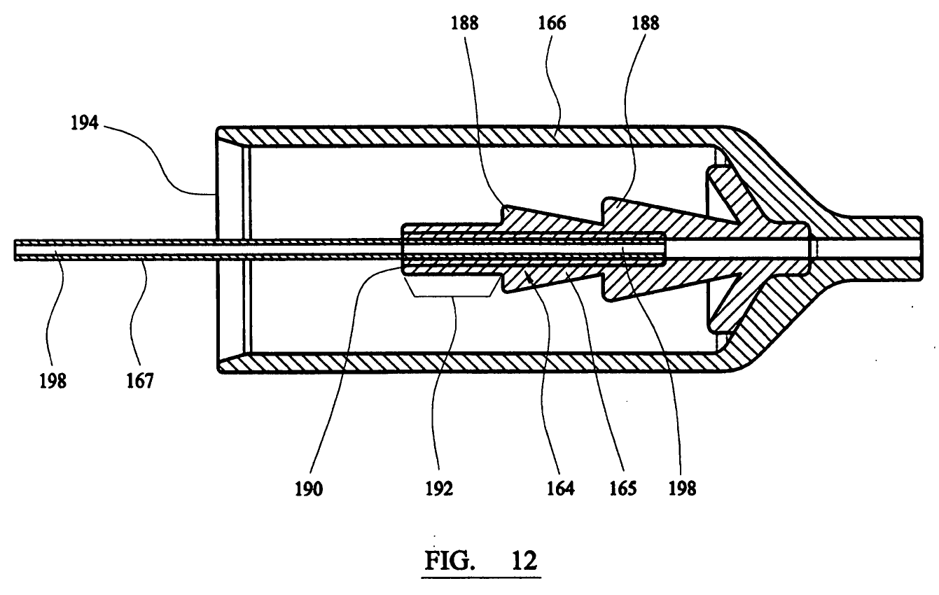

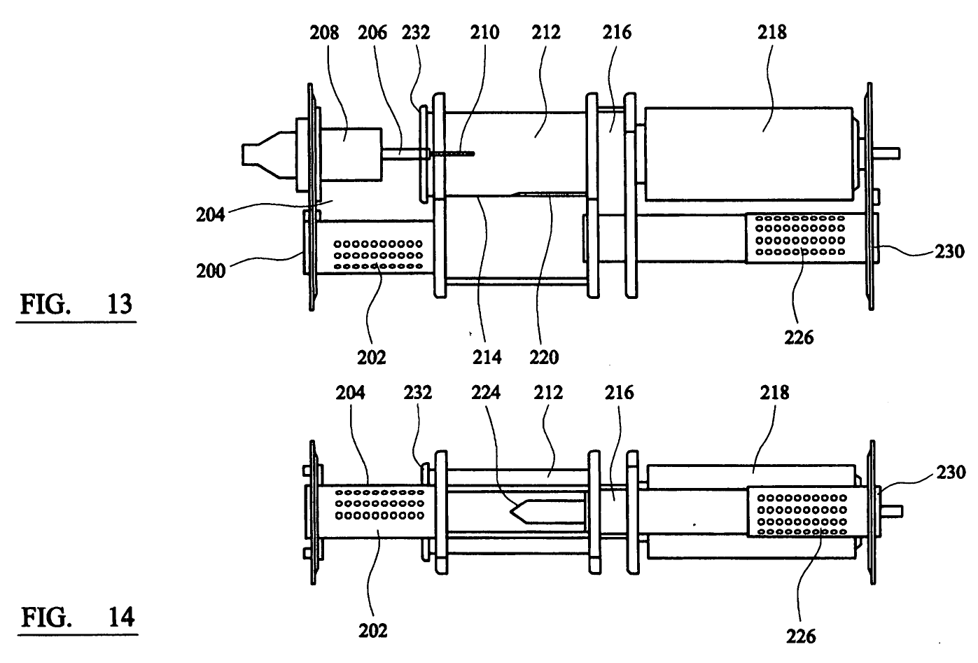

Referring to FIGS. 13-15 of the drawings that follow, there is shown a further embodiment of a gas flow arrangement and apparatus for removing pollutants according to the present invention. In the FIGS. 13-15 embodiment, exhaust gas enters through an inlet 200 into a perforated baffle tube 202 from which all of the entering exhaust gases flow into first chamber 204. In chamber 204, electrode mount 206 over a substantial part of which lies hood 208, mounts an electrode 210 which projects into a second chamber 212 defined by field tube 214. Field tube 214 includes an opening in its end to an intermediate chamber 216, the only exit from which is into filter 218. An alternative flow path is provided via an opening 220 in the wall of field tube 214. The opening 220 is provided with an upstanding lip 222 projecting inwardly into the field tube 214 at at least the upstream portion thereof, but in this embodiment along the full length thereof. Further, the opening 220 comprises a generally V-shaped upstanding leading edge 224 at an upstream end thereof. A fluid flow path leads from field tube 214 via opening 220 leads to a perforated exit tube 226. Perforations 228 in exit tube 126 permit gas passing through filter 218 to re-enter the diverted gas flow leading to exit 230.

It is noted that the leading edge 232 of field tube 214 comprises a returned edge that is curved back on itself whereby the exterior edge of the leading edge 232 of field tube 214 is configured relative to the electrode whereby something else lies between it and electrode and/or electrode mount. In this case, another part of the field tube lies between the external edge and both of the electrode mount 206 and electrode 210.

Upstanding lip 222 and leading edge 224 help to divert particulates away from opening 220 from which it is intended that cleaner gas flows. Together, upstanding lip 222 and leading edge 224 act as means for diverting particulates away from the opening 220.

The electrode mount, hood and electrode are not shown in FIG. 15.

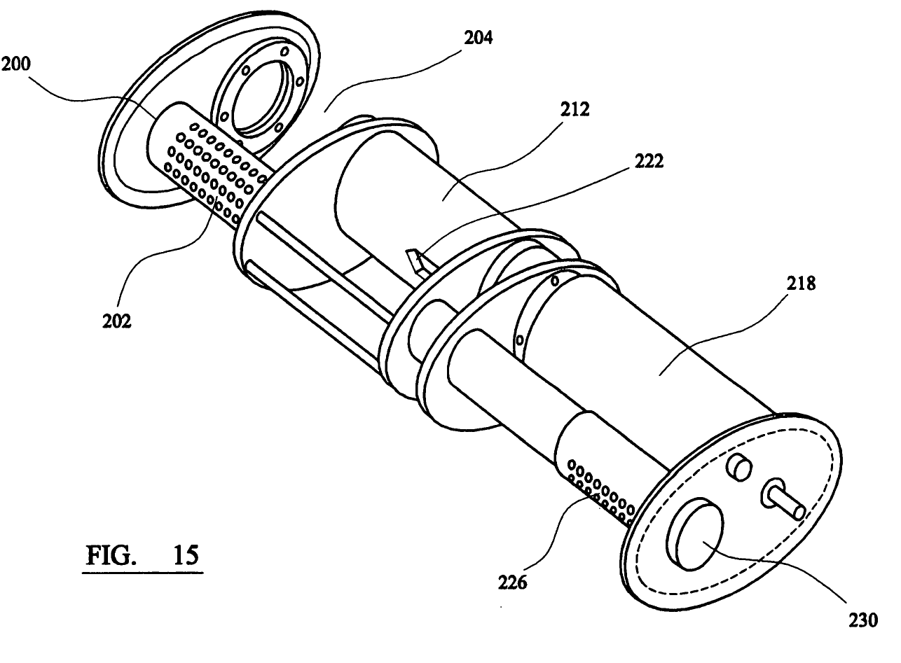

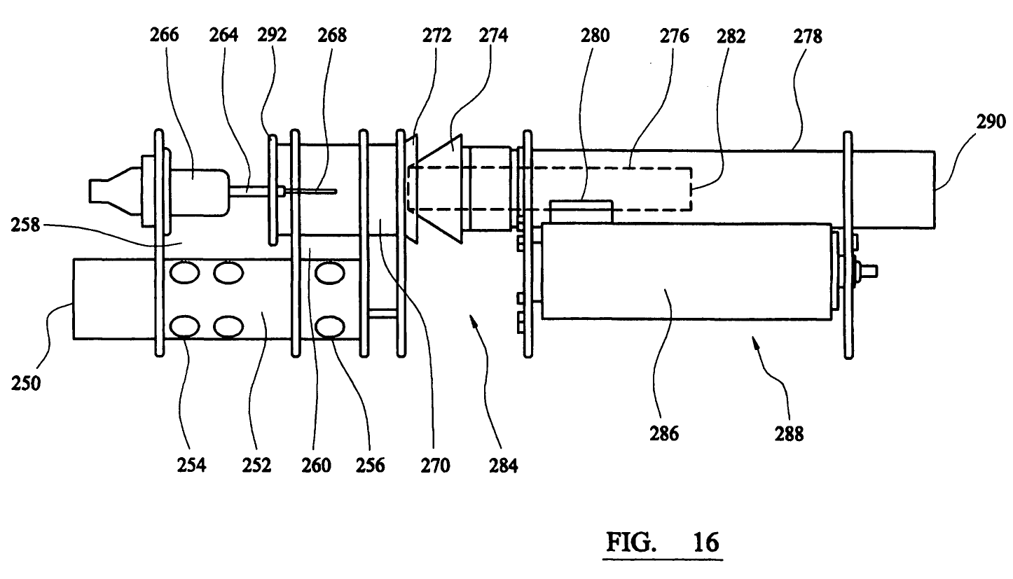

Referring to FIGS. 16 and 17 of the drawings that follow, there is shown a further gas flow arrangement apparatus and apparatus for removing pollutants according to the present invention.

In FIGS. 16 and 17, the apparatus comprises an inlet 250 into which exhaust gas flows into a baffle chamber 252 having first exit ports 254 and second exit ports 256. First exit ports 254 exit to first clamber 258. Second exit ports 256 exit into an intermediate chamber 260 having holes 262 permitting the flow of gas back into first chamber 258. An electrode mount 264 (FIG. 16 only), covered for a substantial part thereof by hood 266 (FIG. 16 only), is provided in first chamber 258 for mounting of an electrode 268 (FIG. 16 only) within a field tube 270. At its downstream end, field tube 270 terminates in an outwardly diverging portion 272 adjacent a generally conical portion 274 within which is a tube 276 extending to an exit tube 278.

In exit tube 278 is provided an opening 280 prior to the exit 282 of tube 276.

In use, exhaust gas flows in via inlet 250 into field tube 270 via first chamber 258. Particulates in the field tube are charged by electrode 268 and tend towards the walls of field tube 270. Thus the particulates are diverted from the central flow of gas through field tube 270. The central flow of gas enters tube 276 into exit tube 278. Other gas bearing a higher loading of particulates exits towards the periphery of, field tube 270 and therefore tends not to enter tube 276. The generally conical portion 274 acts as a deflector for the particulates encouraging them not to enter tube 276. The particulate laden gas exiting field tube 270 other than through tube 276 enters a second intermediate chamber 284 leading to filter 286. Gas exiting filter 286 can only exit the apparatus via opening 280 and into exit tube 278. However the gas exiting filter 286 tends to be at a low velocity compared to the high velocity gas exiting tube 276. The pressure differential causes the gas in third chamber 288 about filter 286 to be drawn through opening 280 into exit tube 278 and hence to outlet 290.

Field tube 270 may include a curved leading edge 292 as described above in relation to FIGS. 13-15.

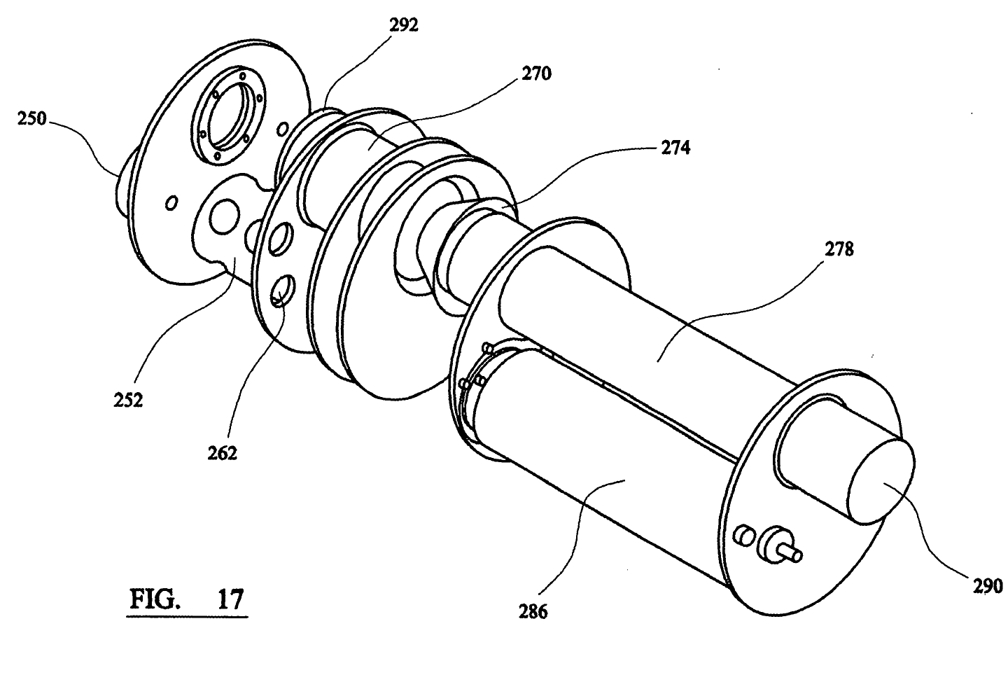

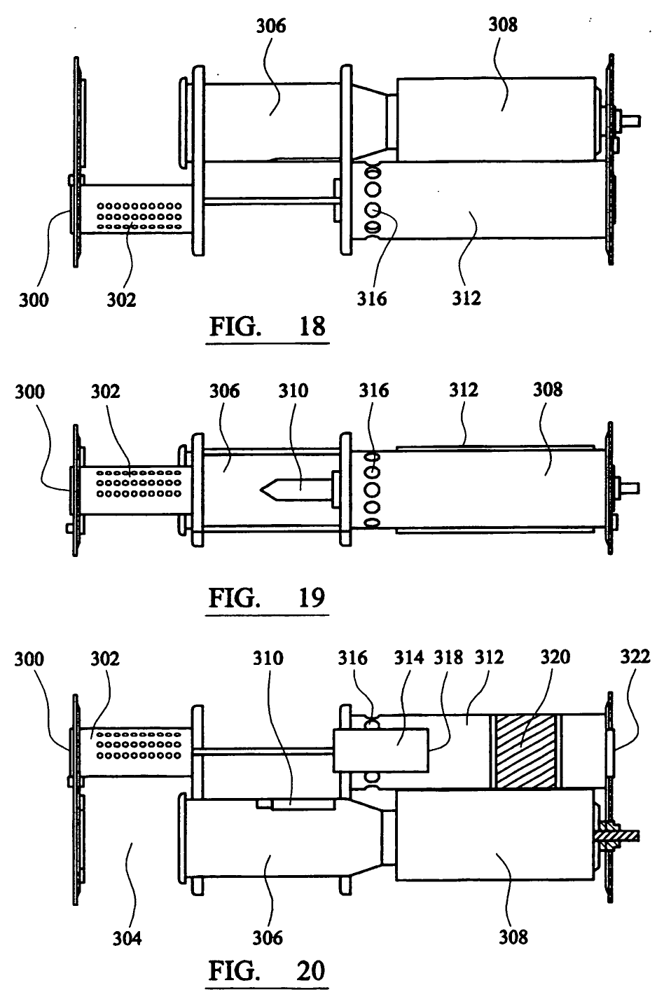

FIGS. 18-20 show a further embodiment of the present invention. In FIGS. 18-20, for clarity the electrode mount and electrode are not shown.

Referring to FIGS. 18-20, there is shown a gas inlet into a perforated expansion chamber 302, from which all the input gas flows into a first chamber 304 and from there into field tube 306 which leads to filter 308. Alternatively, through opening 310 in field tube 306 gas can flow to exit tube 312 in which there is a concentrically mounted flow tube 314 and in an exterior wall of which an opening 316 mounted behind (relative to the gas flow) the exit 318 of tube 314. In exit tube 312 a catalytic body 320, acting as a catalytic converter, optionally can be mounted. In use, gas enters through inlet 300, passes through expansion tube 302 into first chamber 304 and then into field tube 306 in which particulates in the gas flow are charged. Charged particulates tend towards the side wall of field tube 306 and an upstanding lip may be provided around 310 to divert particulates therefrom. Particulates proceeding from field tube 306 to filter 308 are filtered and the gas flow can continue towards exit 322 via holes 316 into exit 312.

Although the first and second gas flow streams are shown separately in the same tube or area of the apparatus, this is for explanatory purposes only and it will be appreciated that in these regions the gas flows are intermingled.

It is believed that the SINTOX FF material has a dielectric strength of between 30 and 40 kV/mm. SINTOX is available from Morgan Advanced Ceramics Limited of Bewdley Road, Stourport-on-Severn, Worcestershire, DY13 8QR, United Kingdom.

In any of the embodiments resistive organic barrier coating may be provided over the inner surface of the tube (eg 114 in FIG. 6) downstream of the beginning of the electrode. The barrier coating is preferably over substantially all of the inner surface of the tube. The coating is TLHB/02 available from Camcoat Performance Coatings of 127 Hoyle Street, Bewsey Industrial Estate, Warrington, WA5 5LR, United Kingdom. It is believed that by reducing the discharge rate of the agglomerated particulates along the tube by providing the coating on at least a part of the tube, the particulates are more likely to stay in the vicinity of the tube.

It is noted that there may be a plurality of apparatus as described above in a gas flow path, in series or in parallel.

Although preferred embodiment are described above in relation to the diversion of particulates from an exhaust gas flow stream, the apparatus can be used to divert particulates in other gas flow streams. However, it is believed currently that the present invention is of particular benefit when used in an internal combustion engine exhaust gas flow.

Accordingly, embodiments of the present invention can divert particulates from a gas stream, the efficiency thereof being enhanced by providing a porous field tube, and with a particulate removal means, such as the filter described herein, can remove particulates from a gas stream.

The apparatus 102 may be placed upstream or downstream of an exhaust catalytic converter (not shown).

Instead of a standard d.c. voltage, high frequency superimposed a.c. may be usable.

The reader's attention is directed to all papers and documents which are filed concurrently with or previous to this specification in connection with this application and which are open to public inspection with this specification, and the contents of all such papers and documents are incorporated herein by reference.

All of the features disclosed in this specification is (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extend to any novel one, or any novel combination, of the features disclosed in this specification (including any accompanying claims, abstract and drawings), or to any novel one, or any novel combination, of the steps of any method or process so disclosed.

1. A mounting apparatus for an electrode, the mounting apparatus comprising a body with means for mounting an electrode, whereby in use the body is partly about the electrode and the electrode projects from the body, the apparatus further comprising at least one external protrusion on the body.

2. A mounting apparatus for an electrode according to claim 1, in which the body is generally cylindrical and the projection is generally radial relative thereto.

3. A mounting apparatus for an electrode according to claim 1, in which the body has a relatively thinner cylindrical elongate section.

4. A mounting apparatus for an electrode according to claim 3, in which the relatively thinner cylindrical elongate section is towards the distal end of the body.

5. A mounting apparatus for an electrode according to claim 1, in which the at least one protrusion is annular (ie 360°) about the body.

6. A mounting apparatus for an electrode according to claim 1, in which the body and at least one protrusion are a one piece structure.

7. A mounting apparatus for an electrode according to claim 1, in which the body at least partly comprises a high electrical resistance material.

8. A mounting apparatus for an electrode according to claim 7, in which that part of the body to be in contact with the electrode comprises a high electrical resistance material.

9. A mounting apparatus for an electrode according to claim 1, in which the body is substantially circular cylindrical.

10. A mounting apparatus for an electrode according to claim 1, in which the non-protruding regions are substantially cylindrical.

11. A mounting apparatus for an electrode according to claim 1, in which the at least one protrusion is generally conical externally.

12. A mounting apparatus for an electrode according to claim 11, in which the at least one protrusion is at least partly hollow.

13. A mounting apparatus for an electrode according to claim 12, in which the at least one protrusion is rebated.

14. A mounting apparatus for an electrode according to claim 11, in which the protrusions are tapered.

15. A mounting apparatus for an electrode according to claim 1, in which all of the body comprises substantially the same material.

16. A mounting apparatus for an electrode according to claim 1, in which there are a plurality of protrusions spaced along the body.

17. A mounting apparatus for an electrode according to claim 16, in which the protrusions are substantially similar.

18. A mounting apparatus for an electrode according to claim 16, in which the protrusions are equally spaced along the body.

19. A mounting apparatus for an electrode according to claim 1, in which the body includes a hole therethrough for mounting an electrode therein.

20. A mounting apparatus for an electrode according to claim 19, in which the hole is longitudinal.

21. An electrode mounting apparatus comprising a mounting apparatus comprising a body with means for mounting an electrode, the apparatus further comprising an electrode about which the body is located, whereby in use the body is partly about the electrode and the electrode projects from the body, the apparatus further comprising at least one external protrusion on the body.

22. An electrode mounting apparatus according to claim 21, in which the electrode is mounted from one end only.

23. An electrode mounting apparatus according to claim 21, in which the electrode projects from an end of the body for forming a corona discharge.

24. A pollutant removal system for at least partly removing at least one pollutant from a gas flow stream, the system comprising an electrode mounting apparatus comprising a body with means for mounting an electrode, whereby in use the body is partly about the electrode and the electrode projects from the body, the apparatus further comprising at least one external protrusion on the body.

25. A pollutant removal system according to claim 24, in which the system comprises means for diverting pollutants to a pollutant remover.

26. A pollutant removal system according to claim 24, in which the system comprises means for charging particulates in the gas stream and a tube through which the gas stream at least partly flows, whereby the tube is at least partly porous to the gas stream and the apparatus additionally comprises means for collecting at least one pollutant.

27. A pollutant removal system according to claim 26, in which the tube is at least partly about the charging means.

28. A pollutant removal system according to claim 27, in which the charging means comprises an electrode.

29. A pollutant removal system according to claim 24, in which the tube is perforated.

30. A pollutant removal system according to claim 29, in which the tube comprises a plurality of holes therethrough.

31-50. (canceled)
